(19) United States
(12) Patent Application Publication
(10) Pub. No.: US 2004/0025623 A1
(43) Pub. Date: Feb. 12, 2004

(54) Device to assist propulson of hand-propelled vehicles

(76) Inventor: Kenneth Barrie Dunbar, Victoria (AU)

Correspondence Address: BAKER & BOTTS, 30 ROCKEFELLER PLAZA, NEW YORK, NY, 10112

(21) Appl. No.: 10/416,595

(22) PCT Filed: Nov. 13, 2001
(86) PCT No.: PCT/AU01/01470

(30) Foreign Application Priority Data
Nov. 14, 2000 (AU) PR 1447

(51) Int. Cl. G05G 1/00

(52) U.S. Cl. 74/544

(57) ABSTRACT

A device with two arms (10, 12) in spaced-apart relationship for secure attachment to a wheel-barrow. A member (26) extends between the two arms (10, 12) and is engaged by an operator contacting the member (26) with their hip/waist area to assist in propelling the wheel-barrow.

### FIELD OF THE INVENTION

This invention relates to a device to assist propulsion of hand propelled vehicles and refers particularly, though not exclusively, to a device attachment to arms of vehicles such as a wheelbarrow to assist in the propulsion of the wheelbarrow.

### DEFINITIONS

Throughout this specification, reference to a vehicle is to be reference to a hand propelled vehicle including such devices as wheelbarrows, trolleys, hand-trucks, perambulators, push chairs, wheelchairs, or the like where the primary propulsion is by human endeavour pushing the vehicle.

### BACKGROUND TO THE INVENTION

When dealing with vehicles as defined above, a significant problem can occur when attempting to push a large load. This can quite often happen when, for example, pushing a wheelbarrow full of bricks, cement, or other heavy load, particularly up an inclined slope.

The wheelbarrow in concept and execution has changed very little. Lighter and stronger materials have been incorporated into its design and manufacture. The use of pneumatic tyres has been a notable advance, which has significantly improved manoeuvrability over rough and uneven terrain. This capability has depended upon the dexterity and ultimately upon the physical strength of the operator.

Due to the design of the conventional wheelbarrow, the manner in which supporting, propelling, restraining and balancing forces are transmitted between the operator and the wheelbarrow have often resulted in injury to the operator. Such injuries include lower back strain; shoulder strain, and damaged: muscles, tendons or ligaments including those in arms and hands. In particular, injuries can occur to the spinal column. Attempts have previously been made to improve the use of wheelbarrows, though these attempts have not been universally satisfactory.

U.S. Pat. No. 5,346,232 to Bushon provides a strap between the handles of the barrow, which may be successively engaged by one of the thighs of an operator as the wheelbarrow is being pushed. Use of such as strap can be inconvenient at times, and may be difficult to effectively engaged, especially by an inexperienced operator.

U.S. Pat. No. 5,806,878 to Mroczka et al describes a wheelbarrow having a strap which is slung over the shoulder of an operator to assist in supporting the wheelbarrow, as well as partly assisting in pushing and pulling the wheelbarrow. Though this arrangement assists in supporting the barrow, it can be inconvenient or counterproductive in assisting to push or pull the wheelbarrow.

It is an object of the invention to attempt to alleviate these and other limitations associated with the existing use of wheelbarrows and similar vehicles.

### SUMMARY OF THE INVENTION

The inventive concept resides in a recognition that hand-propelled vehicles such as wheelbarrows are advantageously operated with the assistance of an aid which allows an operator to directly transmit to the wheelbarrow power from the legs via the relatively strong and stable hip/pelvic region, rather than relying primarily on the relatively weak and unstable spine/arm structure.

Preferably, the spine/arm, structure still supports the wheelbarrow when travelling and steering, but this task is more easily and safely achieved as there is preferably less compression on the spine, and the spine is not inclined as far forward as it may be without the use of the aid. Balance against sideways tilting can preferably also be controlled by the hips also, rather than primarily through the arms and shoulders.

Accordingly, the invention provides a device for assisting in the propulsion of a vehicle, the device including two arms for secure attachment to the vehicle in a spaced-apart relationship, the two arms having a member attached to the respective arms and extending between the arms; wherein the member is able to be contacted by the waist and hip region of an operator to assist in propelling the vehicle.

The member may be flexible, or it may be relatively rigid. Preferably, though, the member is a flexible strap that is readily contacted by an operator.

Preferably, the two arms are substantially parallel when fitted to the vehicle. More preferably, each of the two arms has a horizontal portion and an upright portion.

Advantageously, the horizontal portion and upright portion are connected by an arcuate portion. More advantageously the horizontal, arcuate and upright portions are integral.

Each of the arms may be connected to the vehicle by a connecting means attached to or integral with the horizontal portion. The connecting means may be in the form of a plate having at least one hole therethrough for fastening means. The connecting means may also be a sleeve which can pass over and engage in an appropriate manner a handle of the vehicle.

The member is preferably attached to the upright portion. This attachment may be by means of a sleeve to which the member is attached, the sleeve passing over the upright portion and being releasably secured relative thereto.

### DESCRIPTION OF THE DRAWINGS

FIG. 1 is a perspective view of a device constructed in accordance with an embodiment of the invention.

FIG. 2 is a perspective view in partial breakaway of the device of FIG. 1 as fitted to a wheelbarrow; and

FIG. 3 is a perspective view similar to that of FIG. 1 but showing an alternative embodiment.

### DESCRIPTION OF EMBODIMENTS

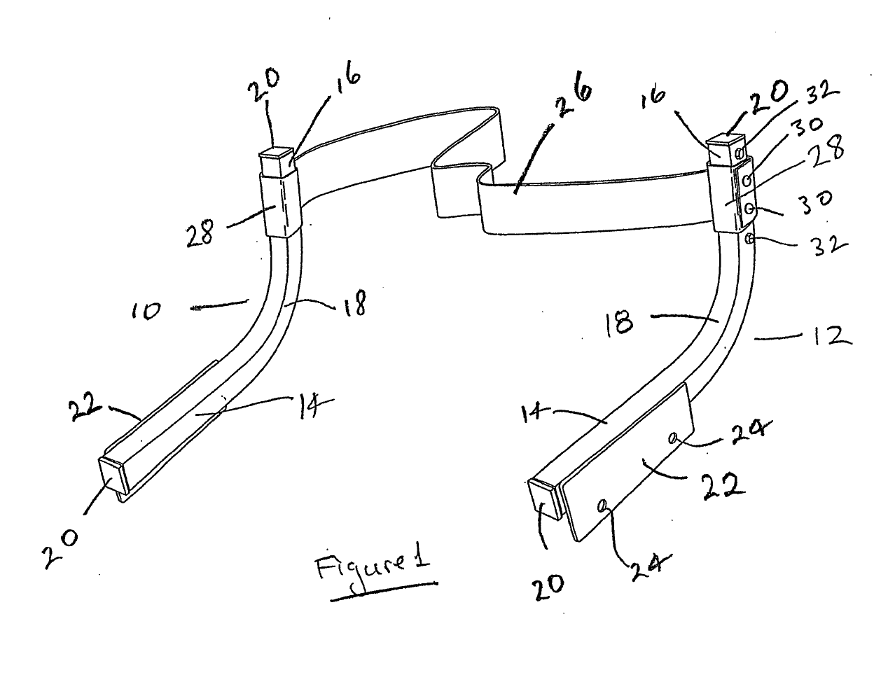

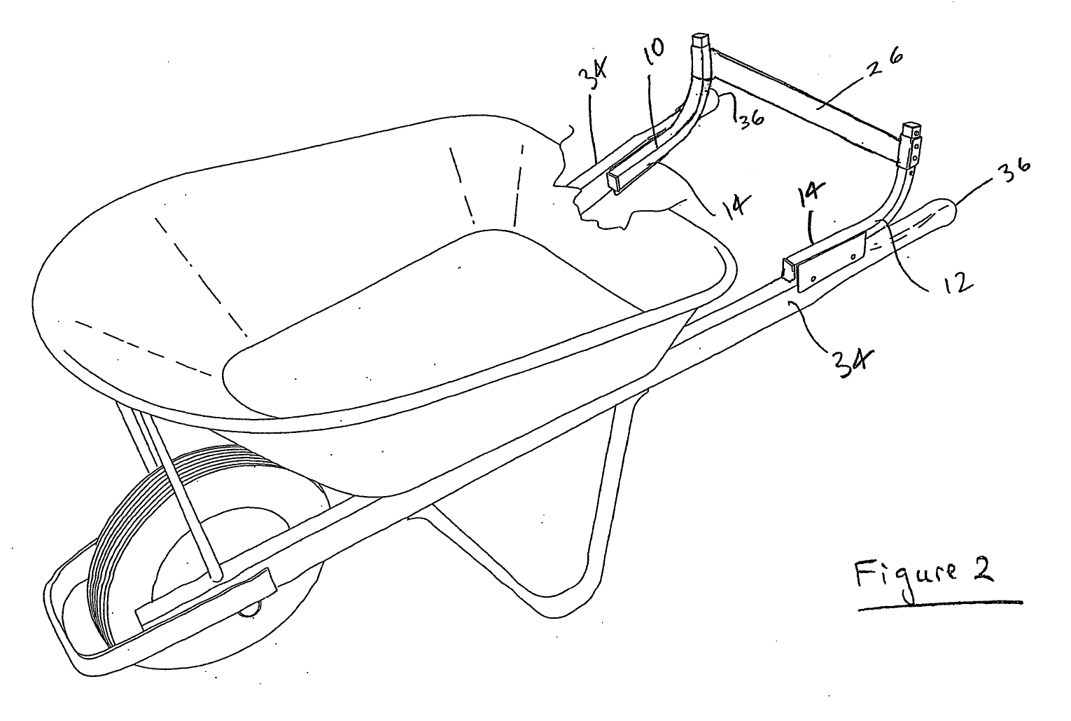

To refer to FIGS. 1 and 2, there is shown a device for assisting in the propulsion of a vehicle, the device having two arms 10, 12. Each of the arms 10, 12 has a generally horizontal portion 14 and an upright portion generally designated as 16 with there being an arcuate portion 18 connecting the horizontal portion 14 and upright portion 16. The three portions 14, 16, 18 are preferably integral. To show they are made from a square-section metal extrusion, although this is only preferred and not essential. End caps 20 may be provided, if desired, so as to protect a user from any rough or raw edges.

Securely attached to the horizontal portion 14, preferably on an outer side thereof, is a connecting means 22 which, in this instance, is in the form of a flat plate. The plate 22 may be attached to the horizontal portion 14 by any suitable means such as, for example, bolts, screws, welding, gluing, or otherwise, as desired. Furthermore, it may be possible for it to be made integral with the horizontal portion 14.

The plate 22 has a number of holes 24 therethrough. The holes enable a fastening means such as a nail, screw, bolt, or the like to be used to attach the plate 22 and thus each arm 10, 12 to the vehicle.

A flexible member 26 is provided is made of a suitable fabric such as, for example, a plasticised canvas, cotton canvas, or the like. Any suitable fabric may be used provided it possesses the necessary flexibility and strength to achieve the results required. At each end of the flexible member 26 is securely attached to a connecting sleeve 28. This is normally by means of screws, rivets, or bolts 30. The sleeve 28 is sized and adapted to pass over the upright portion 16 in a sliding but reasonably tight fit. It is intended to not extend along each of the arms 10, 12 beyond the upright portion 16. To this end, screws or bolts 32 may be provided to act as upper and lower end stops for the sleeve 28.

When fitted to a vehicle such as a wheelbarrow (FIG. 2), the horizontal portions 14 are placed on or adjacent the arms 34 of the wheelbarrow, and the connecting means 22 is used to securely connect the device to the wheelbarrow. As stated earlier, this may be by bolts, screws, nails or the like. The horizontal portion 14 will be on the top of, or next to, the arms 34 as can be seen by the comparing the location of arm 10 to arm 12.

A bolt 32 above a sleeve 28 can be removed to enable sleeve 28 to be removed from upright portion 16. The sleeve 28 can then be rotated to wind the flexible member 26 thereon until the flexible member 26 is quite tight. The sleeve 28 can then be placed on upright portion 16 and bolt 32 reinstated. This may be performed for one or both sleeves 28.

The outer end 36 of each of the arms 34 is, as usual, shaped like a handle. These are still able to be gripped by a user. However, when pushing with a large load in the wheelbarrow, up an inclined slope, or a combination of both, the user can lean forward slightly and the hip/pelvic portion of the user can press against the flexible member 26 to assist in propelling the wheelbarrow. In this way, not only the arm and leg propulsion, but the assistance of the hip and pelvic propulsion, provides increased forward momentum and stability.

Further, driving the wheelbarrow directly from the hip and pelvis area has advantages that arise from permitting free movement of the operator's legs, in contrast with prior art arrangements in which the thighs must be pressed against a flexible strap. In such arrangements, the movement of an operator's legs is restricted as the thighs are periodically pressed against the strap. Using the thighs in this way is not suitable for restraining the progress of a wheelbarrow downhill by placing the strap behind the thighs.

With the described device, there are two configurations with respect to the relative positions of the wheelbarrow and operator when negotiating a downhill slope.

When the wheelbarrow precedes the operator, a restraining force is applied by inclining the body backward as far as possible. This inclination and the resulting force is limited by the user's feet fouling the cross-bracing of the wheelbarrow's support legs.

When the user precedes the wheelbarrow, with back to barrow freedom of movement of legs and safe placement of feet becomes possible.

The member 26 of the device, in this case, directly transmits the restraining force of the legs via the buttocks or lower back of the operator, to the wheelbarrow, preventing overrun.

The contact with the member 26 will also assist in stabilising the wheelbarrow against rotational movement—when one arm 34 rises and the other arm lowers—which is a significant problem when carrying semi-fluid loads such as concrete and mortar.

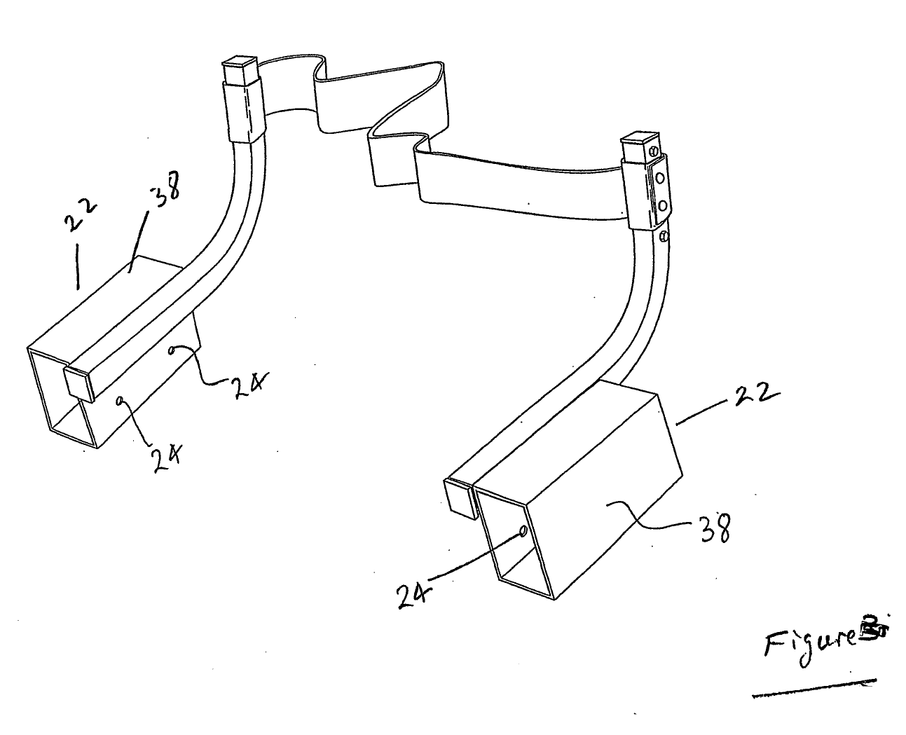

The device of FIG. 3 is generally identical to that of FIGS. 1 and 2, except the connecting means 22 is, in this instance, in the form of a sleeve 38 which is adapted to pass over the arms 34 of the wheelbarrow and to jam thereon. Arms 34 of wheelbarrows such as that illustrated generally increase in size along their length and, therefore, a sizeable jamming force may be able to be created. However, holes 24 (as in the past) may be provided for fastening devices, if desired.

Alternatively connecting means may also be used. For example, worm-drive clamps (such as radiator hose clamps) may be used.

Furthermore, the arms 10, 12 may be permanently attached to arms 34 of the wheelbarrow. In such a form, the horizontal portions 14 and arcuate portions 18 may not be required, with the upright portions 16 being attached directly to arms 34. Also, the member 26 may be relatively rigid such as for example, a length of padded timber, steel, or the like.

It will be understood that the invention disclosed and defined in this specification extends to all alternative combinations of two or more of the individual features mentioned or evident from the text or drawings. All of these different combinations constitute various alterative aspects of the invention.

1. A device to assist the moving of a hand propelled vehicle, the device including two arms each for attachment to one of two handles of the vehicle, the two arms each having a horizontal portion and an upright portion; the device including a flexible member each end of which is securely attached to a sleeve, each sleeve being able to be releasably attached to the upright portions of the respective arms and extend between them; wherein said flexible member is contactable by the hip/pelvic region of an operator to assist in the propulsion of the vehicle by the continuous transmission of a force to the vehicle by the operator.

2. A device as claimed in claim 2, wherein the flexible member is elevated above the plane of the vehicle handles.

3. A device as claimed in claim 1 or claim 2, wherein the horizontal and upright portions are integrally connected by an arcuate portion.

4. A device as claimed in any one of claims 1 to 3, wherein the horizontal portion of each arm includes a connecting means, each of the arms being fitted to the handles by the connecting means.

5. A device as claimed in claim 4, wherein the connecting means includes a plate having at least one hole therethrough for a fastening means.

6. A device as claimed in claim 4, wherein each connecting means includes a sleeve which can pass over and securely engage the handles of the vehicle.

7. A device as claimed in claim 4, wherein the connecting means includes a worm-drive clamp.

8. A device as claimed in any one of claims 1 to 7, wherein the upright portion has upper and lower end stops for the sleeve.

9. A device as claimed in any one of claims 1 to 8, wherein each sleeve passes over the respective upright portion with a sliding but reasonably tight fit.

10. A device as claimed in claim 9, wherein one or both of the sleeves can be rotated to wind the flexible member thereon until the flexible member is tight before the sleeve is passed over and attached to the upright portion.

11. A device as claimed in any one of claims 1 to 10, wherein each sleeve is rectangular.

12. A device as claimed in any one of claims 1 to 11, wherein the vehicle is a wheelbarrow the device being attached to the handles of the wheelbarrow.
